(19) United States
(12) Patent Application Publication
(10) Pub. No.: US 2023/0263603 A1
(43) Pub. Date: Aug. 24, 2023

(54) IMPLANTATION SYSTEM AND ADD-ON ELEMENT FOR AN IMPLANTATION SYSTEM

(71) Applicant: Frank Zastrow, Heidelberg (DE)

(72) Inventor: Frank Zastrow, Heidelberg (DE)

(21) Appl. No.: 18/005,174

(22) PCT Filed: Jul. 26, 2021
(86) PCT No.: PCT/DE2021/200098

§ 371 Date: Jan. 11, 2023

(30) Foreign Application Priority Data
Jul. 31, 2020 (DE) 10 2020 209 688.0

(51) Int. Cl. A61C 8/00

(52) U.S. Cl. CPC A61C 8/0068; A61C 8/0089

(57) ABSTRACT

An implantation system has an implant body, an add-on element, and a connection element. The implant body has a connection inner profile or a connection outer profile; which cooperates with a connection outer profile or with a connection inner profile of the add-on element. The add-on element is connectable to the implant body in a rotationally-fixed manner. The connection element is screwable through an aperture of the add-on element into a thread of the implant body in order to detachably connect the add-on element to the implant body. The disclosure also describes an add-on element for an implantation system. The add-on element has a connection inner profile or a connection outer profile for producing a rotationally-fixed connection to a connection outer profile or to a connection inner profile of an implant body, and having an aperture for introducing a connection element.

### BACKGROUND

### Technical Field

The present disclosure relates to an implantation system with an implant body, an add-on element, and a connection element.

Furthermore, the disclosure relates to an add-on element for an implantation system.

### Description of the Related Art

Dentists performing surgeries, oral surgeons, and maxillofacial surgeons are often faced with the challenge that bone has been lost in the oral cavity as a result of bone atrophy, accidents, periodontitis, or tooth extraction. The choice is then frequently made to use a dental implant to replace the missing tooth or missing teeth.

A dental implant is an “alloplastic, ready-made component” inserted into the jawbone. This area of dentistry, which is concerned with the insertion of dental implants into the jawbone, is referred to as implantology. Because dental implants can be used to support dental prostheses, they assume the function of artificial tooth roots.

For this purpose, they are either screwed or inserted into the jaw bone (endosseus implants) by means of a screw thread. Within three to six months, they bond with the surrounding bone to form a fixed, extremely resilient support unit (osseointegration).

The design of the implant dictates the surgical insertion technique. The production of the superstructure—of the tooth set to be integrated into the implants—results from the design of the abutment—of the implant part protruding from the jawbone.

Since the 1980s, dental implants have typically been made of titanium, but also of ceramic materials or plastic. Implant systems are either placed crestally (at bone level) or subcrestally (1 mm to 3 mm below bone level) so that the bone can grow over the implant shoulder.

Dental implants with a so-called conical implant-abutment connection are typically placed in a subcrestal position, i.e., the ideal positioning for this implant type is subcrestal positioning.

Moreover, a more or less pronounced recession in the bone usually occurs over the years, which is another reason why the majority of today's implant systems are placed slightly subcrestally (1 mm to 3 mm) below bone level in order to prevent the rough threads of the implant from emerging prematurely, which, in addition to aesthetic deficits, leads to the accumulation of plaque and thus to a high risk of infection and peri-implantitis.

In approximately 50% of cases, a bone deficit resulting from bone atrophy, accidents, periodontitis, or tooth extraction exists, which has to be reconstructed by building up the bone (augmentation) if dental implants are to be used. It is necessary to reconstruct these bone deficits prior to or at the same time as the placement of an implant so that the dental implants have a stable foundation and a stable support in the bone—especially in the case of subsequent loading.

Where bone is built up using bone shells, it is to be avoided that the implant shoulder come to rest in a purely cortical bone—especially in the case of avascular bone shell transplants, as they have to undergo remodeling or resorption processes afterwards. There should, therefore, be a gap of 0.5 mm to 1 mm between the implant shoulder and the avascular bone shell. The same rule also applies in the case of lateral augmentation, when a bone shell is built up laterally. In this case too, said bone shell should not be in direct contact with the implant shoulder.

In the case of a vertical build-up with associated implantation in the lower jaw, the shoulder of the implant should sit 2.5 mm deeper than bone level. In the case of a vertical build-up in the upper jaw, the implant shoulder should sit at least 1 mm below bone level.

When a tooth is implanted with simultaneous bone build-up, in most cases submerged healing is recommended, since open healing would mean that the built-up bone has contact with the oral cavity via a gap, which increases the risk of bacterial contamination and the risk of implant and bone loss.

It is, however, a problem that no suitable implant systems exist—particularly in cases of planned, subcrestal implant positioning with simultaneous bone build-up and subsequent submerged healing.

Several problems occur in alveolar ridge augmentation with simultaneous (subcrestal) implant positioning. In the current state of the art, implant systems cannot be positioned subcrestally in compromised anatomical bone situations (e.g., in the case of thin bone wall of 2 mm to 3 mm in the lateral region of the upper jaw, sinus region) without there being a risk of them becoming unstable due to lack of retention/friction in the local bone and being lost. Thus, typically, the bone first has to be built up (e.g., sinus lift), i.e., the bone build-up has to take place, and only in a second step (after four to six months) can the implant be inserted. This means a considerable loss of time. Moreover, bone easily grows over the subcrestally positioned implant during the healing phase. When the region of the implant is exposed again after the healing phase (after approximately three to six months), firstly, it is difficult to relocate the implant and, secondly, it is difficult to remove the bone over the implant without damaging the inner or outer surface of the implant.

### BRIEF SUMMARY AND GENERAL DESCRIPTION

The present disclosure is therefore based upon the object of specifying an implantation system which solves the problems described above—in particular, for subcrestal implant positioning with simultaneous bone build-up and subsequent submerged healing.

Furthermore, an add-on element for an implantation system is to be specified.

According to the present disclosure, an implantation system—preferably designed for submerged healing—has an implant body, designed in particular for subcrestal positioning, an add-on element, and a connection element, wherein the implant body has a connection inner profile or a connection outer profile, which cooperates with a connection outer profile or with a connection inner profile of the add-on element such that the add-on element can be connected to the implant body in a rotationally-fixed manner, and wherein the connection element can be screwed through an aperture of the add-on element into a thread of the implant body in order to detachably connect the add-on element to the implant body.

Ab add-on element is also claimed—in particular, for an implantation system—with a connection inner profile or with a connection outer profile for producing a rotationally-fixed connection to a connection outer profile or to a connection inner profile of an implant body and an aperture—in particular, for introducing a connection element.

It should be noted that the add-on element can have individual, and optionally all, features and advantages of the add-on element of the implantation system according to the description below.

It has been recognized in a manner according to the present disclosure that the combination of an implant body with an add-on element, which can be arranged on the implant body in a rotationally-fixed manner and can be held captively on the implant body via a connection element, enables an ideal, and in particular subcrestal, positioning of the implant body. The connection element ensures that a firm and gap-free bond is provided between the implant body and the add-on element. This is particularly advantageous in anatomically difficult situations in which the surgeon has only a minimal overview. In a further manner according to the present disclosure, the add-on element ensures that bone is prevented from growing over the implant body, such that the space is kept open for subsequent connection geometries. The implantation system according to the present disclosure thus makes it possible to insert the elements already connected to one another as a gap-free unit into the bone such that a correct seat is always ensured. For example, in the case of insertion into the sinus wall, the entire implantation system can be left in situ during the healing period. After healing, the add-on element can be removed in a simple manner, and supraconstruction can take place. The rotationally-fixed connection realized by the corresponding connection inner and connection outer profiles makes it possible for sufficient torque to be transmitted from the add-on element to the implant body such that they can be inserted together into the bone. It is conceivable that a torque transmission of at least 30 N·cm, in particular of at least 40 N·cm, and preferably of at least 50 N·cm, is achieved. A further advantage of the combination of the connection inner profile and connection outer profile is that indexing can be realized, i.e., the add-on element can be arranged in a defined position relative to the implant body. Furthermore, it is possible for further elements to be connected to the implant body after healing and removal of the add-on element—for example, a gingiva shaper or the like.

In the case of an insertion with bone build-up in the form of a shell, there are various variants. For example, the occlusal bone shell can first be screwed tightly using small osteosynthesis screws, then a borehole can be produced in the bone shell using a trephine drill, and then the implant body can, together with the add-on element arranged via the connection element, be fixed in an ideal subcrestal—position.

Furthermore, it is conceivable that the insertion of the unit consisting of implant body with the add-on element arranged over the connection element be first carried out. The shell is subsequently positioned thereover and perforated. In addition to the use of a trephine drill, the bone shell can subsequently also be perforated using a conical diamond drill.

In the context of this disclosure, the term “implant body” describes the actual implant which remains in the jawbone and supports the abutment or the suprastructure.

In the context of this disclosure, the term “subcrestal” describes a positioning of the implant body such that the upper edge of the implant body lies below bone level—for example, at least 1 mm below bone level.

In an advantageous manner, in the state connected to the implant body, and in particular in the completely inserted state, the add-on element can project out of the implant body, i.e., from the shoulder of the implant body, by 1.5 mm to 4.5 mm, in particular by 1.5 mm to 3.5 mm, and preferably by 2.0 mm to 2.5 mm, or protrude therefrom. This makes it possible for the add-on element in the implanted state to project out of the bone level—preferably by 0.5 mm to 1.0 mm—or protrude therefrom, in order to prevent overgrowth. At the same time, submerged healing is made possible. It is thus made possible, using structurally simple means, that contamination, e.g., with bacteria, be avoided due to the submerged healing, and moreover, despite a subcrestal implant positioning, that bone be prevented from growing over the implant during the healing phase.

In a particularly advantageous manner, the add-on element can have an external thread, at least in regions. This has an advantage that, during implantation into a thin bone layer, e.g., in the case of a sinus lift, the implant body can be inserted so deeply that its external thread no longer sufficiently catches in the bone; however, the entire unit is securely fixed in this position via the external thread of the add-on element such that safe healing is achieved. If sufficient bone is present for fixing the implant body, the add-on element can have a smooth surface, such that osseointegration is prevented, and the add-on element can be easily removed again after becoming ingrown. Alternatively or additionally, the outer wall of the add-on element can run conically or be designed as a straight cylinder. An at least slightly conical configuration has the advantage that a force acting on the implant body in the longitudinal direction is exerted, which force contributes to the stabilization of the implant body in the desired position. Particularly with implantation in the sinus region, a conical embodiment of the add-on element prevents the unit from being placed in the direction of the maxillary sinus. A further advantage is that the add-on element can be removed more easily after the healing period.

According to an advantageous embodiment, the add-on element can have an active profile for an active element, such that the unit consisting of implant body, connection element, and add-on element can be implanted in a particularly simple manner. Due to the rotationally-fixed connection between the implant body and the add-on element, the entire unit consisting of implant body, add-on element, and connection element can be implanted via a single active element, e.g., a tool, wherein said tool engages in the active profile. The active profile can, for example, be any drive profile—preferably a hexagon, star, multi-tooth, octagon, 3PG, etc. Active profiles that allow unambiguous indexing are particularly advantageous. The active profile can preferably be designed to ensure a torque transmission of at least 30 N·cm, in particular of at least 40 N·cm, and preferably of at least 50 N·cm. According to an advantageous embodiment, the width across flats of the active element, and particularly in the case of a hexagon, can be 1.6 mm to 2.5 mm, preferably 1.9 mm to 2.4 mm, and in particular 2.3 mm. Such a width across flats has the advantage that a sufficiently sufficient torque transmission is ensured and at the same time builds the structure to be as small as possible.

A closing element is advantageously arranged which can be connected to the add-on element in a form-fitting and/or force-fitting manner in order to close the aperture of the add-on element. The closing prevents germs from entering the implant and the surrounding bone. In a further advantageous manner, the closing element and the add-on element can be designed such that, when they are connected together with the implant body, and in particular completely screwed in in each case, a head of the closing element and a head of the add-on element project out of the implant body or from the implant shoulder together by less than 5 mm, in particular less than 4 mm, and preferably less than 2.8 mm, or protrude therefrom. Thus, when the implant body is positioned subcrestally, bone tissue is prevented from growing over the implant body, and at the same time submerged healing is made possible. When add-on element and closing element project out by less than 5 mm, submerged healing can take place, wherein the dimensioning is sufficiently large that the individual elements can easily be produced. A projection of less than 4 mm has the advantage that the surgeon can close the incision more easily. A projection of less than 3 mm has the advantage that the incision can be closed by the surgeon particularly easily and can heal well. A further advantage is that the patient perceives such a low height to be less bothersome. Specifically, the head of the closing element could have a height of less than 2.5 mm, in particular of less than 1.5 mm, and preferably of less than 0.5 mm.

According to an advantageous embodiment, a thread for the closing element is formed on the active profile of the add-on element. Due to this design measure, the entire device is extremely small, and at the same time a secure connection is ensured between the add-on element and the closing element. The closing element can also be fastened in another way—for example, via a bayonet connection, a plug connection, or latching connection.

Advantageously, the implant body is designed so as to be arranged below the bone level. A corresponding dimensioning has the advantage that an ideal subcrestal positioning of the implant body can be achieved in a particularly simple manner.

According to an advantageous embodiment, the connection inner profile of the implant body and the connection outer profile of the add-on element or the connection outer profile of the implant body and the connection inner profile of the add-on element can be designed such that a torque transmission of at least 30 Ncm, in particular of at least 40 Ncm, and preferably of at least 50 N·cm, is possible. If the connection inner and connection outer profile are correspondingly matched to one another, sufficient torque can be transmitted from the add-on element to the implant body such that they can be introduced together into the bone.

Advantageously, the connection inner profile of the implant body and the active profile of the add-on element are at least substantially identical. This has the advantage that the implant body and the add-on element can be actuated by the same tool.

According to an advantageous embodiment, an instrument, and in particular a hand instrument, is arranged, wherein the instrument has a shaft, and wherein an active element is formed at the distal end of the shaft, said active element corresponding to the active profile of the add-on element. The instrument can, for example, be configured in such a way that it can be connected to and optionally driven by an elbow. Furthermore, it is possible for the instrument to be implemented as a hand instrument. Since the instrument can engage on the add-on element, the add-on element, together with the implant body connected in a rotationally-fixed manner, can be inserted into the bone such that the instrument serves in this case as an insertion instrument. For this purpose, a ratchet mechanism could, advantageously, also be embodied. It is also conceivable, however, that the instrument serve only for handling the add-on element, in order to receive the latter, to transfer it to the implant body, and to insert it into said implant body or to place it thereon.

In an advantageous manner, the elongate shaft is tubular, wherein a rod can be arranged or is arranged movably within the shaft, and wherein an active geometry is formed at the distal end of the rod and corresponds to an engagement point of the connection element. This design measure makes it possible to receive the add-on element with the active element of the tubular shaft and to place it on the implant body, wherein the connection element also used can be driven by the active geometry of the rod, such that a fixed connection is produced between the add-on element and the implant body. In order to facilitate the decoupling of the shaft and the add-on element or of the rod and the connection element, the active geometry of the rod and the engagement point of the connection element can preferably be matched to one another in such a way that no force-fitting connection is produced, i.e., sticking is avoided. Specifically, the rod can be part of a further instrument, and preferably a hand instrument.

In a particularly advantageous manner, a release instrument with a release rod instrument can be arranged. In this case, set back from the distal end of the release rod, a release thread can be formed. The release instrument serves to remove the add-on element from the implant body as easily, non-destructively, and safely as possible after the healing period. This can sometimes be possible only with difficulty if the add-on element has grown into the tissue. For release, the distal end of the release rod is inserted into the aperture of the add-on element, and the release thread is screwed into a lower thread of the add-on element. Since the release thread is set back from the distal end of the release rod, it abuts against the base of the implant body such that, when the release rod is screwed in further, the add-on element is pulled off the implant body. In this case, sufficient force is exerted on the add-on element that it can even be lifted off when it is partially grown into surrounding tissue.

### BRIEF DESCRIPTION OF THE SEVERAL VIEWS OF THE DRAWINGS

There are various possibilities for designing and developing the teaching of the present disclosure in an advantageous manner. To this end, reference is made to the following explanation of preferred exemplary embodiments of the present disclosure based upon the drawings. In connection with the explanation of the preferred exemplary embodiments of the disclosure based upon the drawings, generally preferred developments and further developments of the teaching are also explained. In the following:

FIG. 1 is a schematic representation, a perspectival view of an exemplary embodiment of an implant body of an implantation system according to the present disclosure;

FIG. 2 is a further schematic representation, a cutaway view of an exemplary embodiment of the implant body according to FIG. 1;

FIG. 3 is a further schematic representation, showing a cutaway view of an exemplary embodiment of the implant body according to FIG. 1;

FIG. 4 is a schematic representation, showing a side view of an exemplary embodiment of an add-on element of an implantation system according to the present disclosure;

FIG. 5 is a further schematic representation, showing a cutaway view of an exemplary embodiment of the add-on element according to FIG. 4;

FIG. 6 is a schematic representation, showing a side view of an exemplary embodiment of a connection element of an implantation system according to the present disclosure;

FIG. 7 is a further schematic representation, showing a cutaway view of an exemplary embodiment of the connection element according to FIG. 6;

FIG. 8 is a schematic representation, showing a side view of an exemplary embodiment of a closing element of an implantation system according to the present disclosure;

FIG. 9 is a further schematic representation, showing a cutaway view of an exemplary embodiment of the closing element according to FIG. 8;

FIG. 10 is a schematic representation, showing an exploded view of the elements shown in FIGS. 1 through 9;

FIG. 11 is a schematic representation, showing a side view of an exemplary embodiment of an instrument of an implantation system according to the present disclosure;

FIG. 12 is a schematic representation, showing a side view of an exemplary embodiment of a rod of an implantation system according to the present disclosure; and

FIG. 13 is a schematic representation, showing a side view of an exemplary embodiment of a release instrument of an implantation system according to the present disclosure.

### DETAILED DESCRIPTION

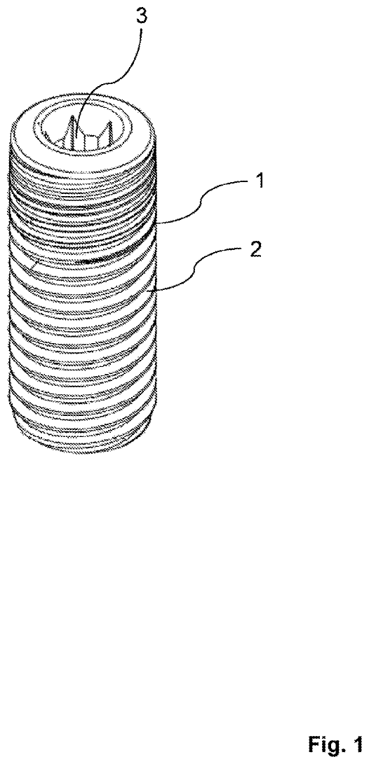

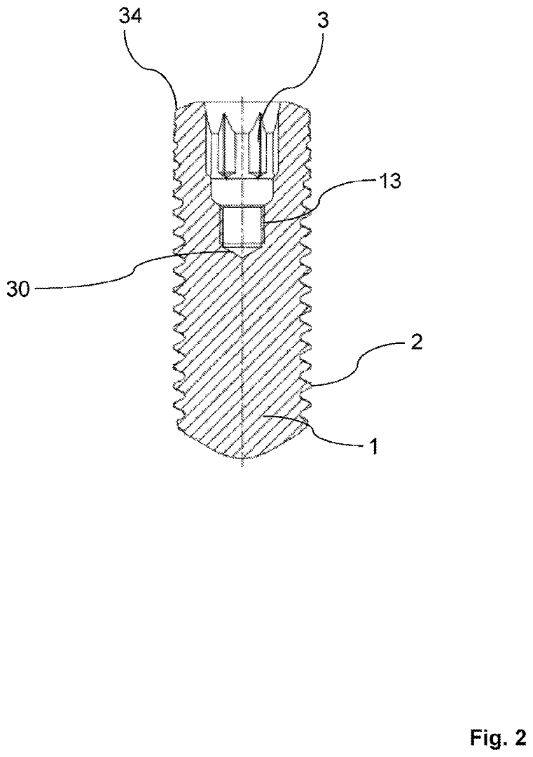

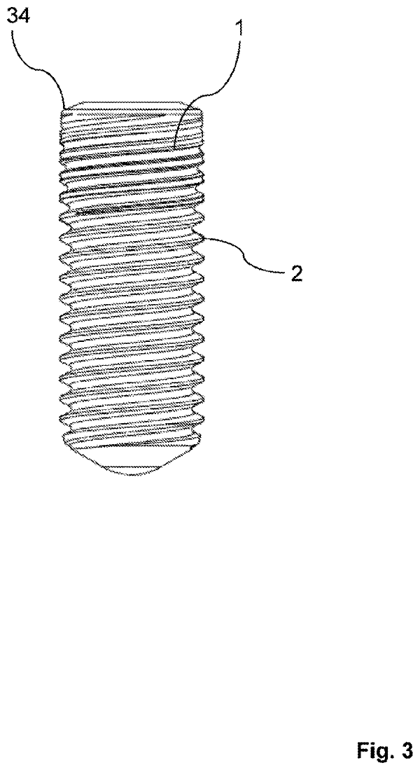

FIGS. 1 through 3 show, in different representations, an exemplary embodiment of an implant body 1 of an implantation system according to the present disclosure. The implant body 1 has a thread 2 on its outer surface and is substantially cylindrical, wherein a geometry deviating from a cylinder is possible, and a thread does not necessarily have to be formed. Furthermore, a connection inner profile 3 is formed in the implant body 1, and the implant shoulder 34 is shown in the figures.

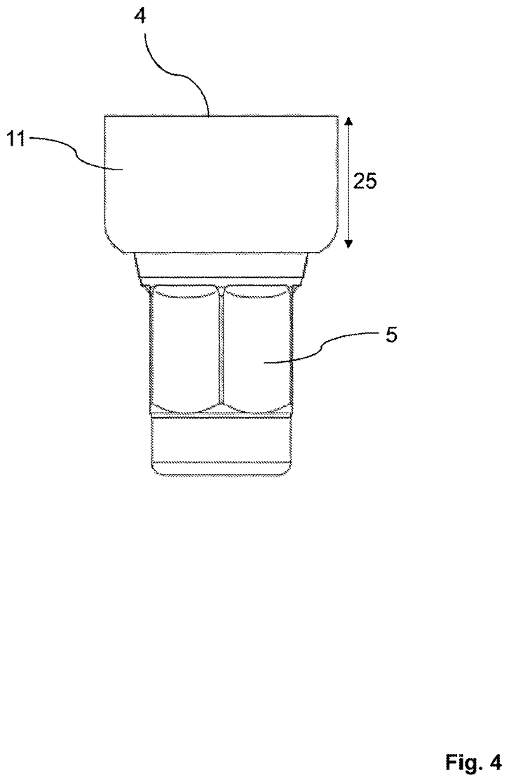

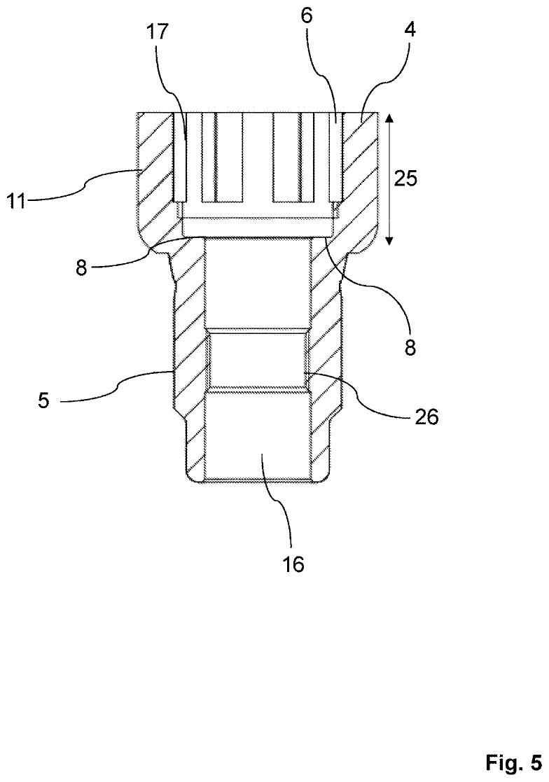

FIGS. 4 through 6 show an exemplary embodiment of an add-on element 4 of an implantation system according to the present disclosure. The add-on element 4 has a connection outer profile 5, which corresponds to the connection inner profile 3 of the implant body 1 according to FIGS. 1 through 3. The add-on element 4 can thus be introduced into the implant body 1, wherein the connection inner profile 5 and the connection outer profile 3 realize a rotationally-fixed connection. It should be noted at this juncture that it is also conceivable that the add-on element 4 have a connection inner profile and the implant body 1 have a connection outer profile, such that the add-on element 4 is placed on the implant body 1 and is not inserted into the implant body 1, as is the case in the exemplary embodiment described here. In the exemplary embodiment shown here, the connection inner profile 3 and the connection outer profile 5 are designed as hexagonal profiles, which are particularly well suited for transmitting the required torques. However, other geometries for the connection inner profile 3 and the connection outer profile 5 are also conceivable. Furthermore, it can be clearly seen in FIG. 5 that the add-on element 4 has an additional, lower thread 26. This serves to hold the connection element 10 before it is screwed further into the thread 13 of the implant body 1. Thus, the thread 12 of the connection element 10 and the lower thread 26 of the add-on element 4 correspond.

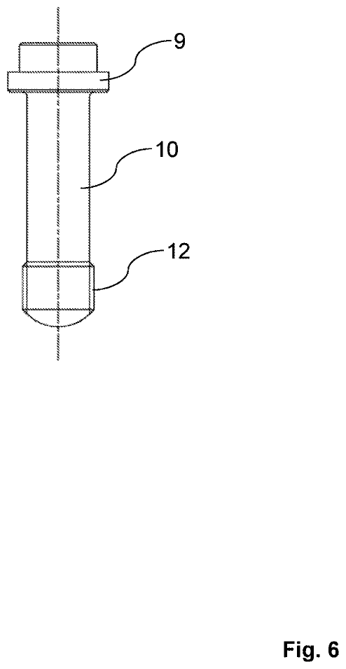

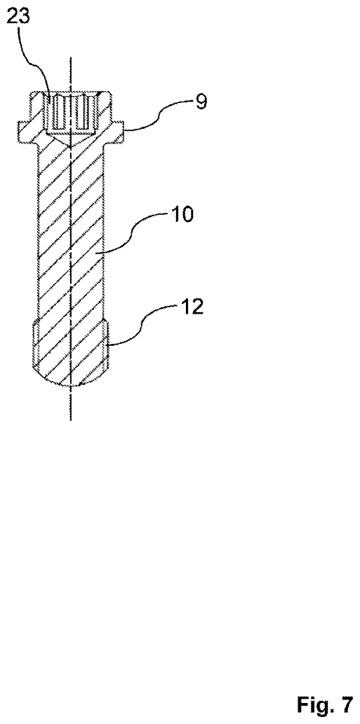

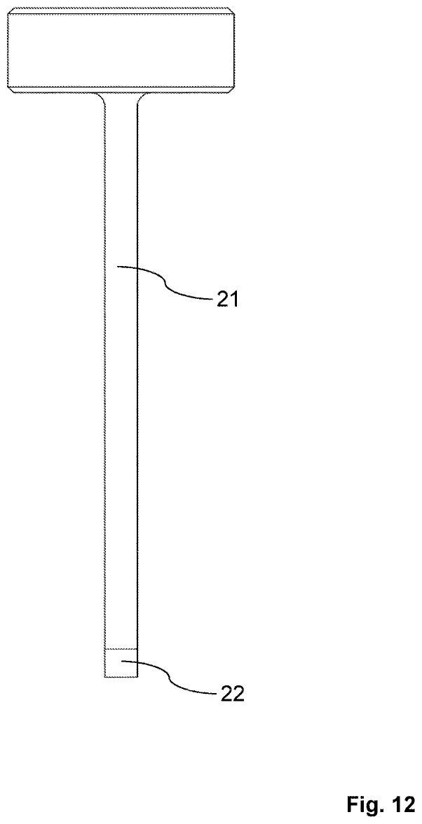

Furthermore, an active profile 6 for an active element 7 (FIG. 12) is formed on the add-on element 4. FIG. 5 clearly shows that the add-on element 4 has a projection 8 on which a shoulder 9 of the connection element 10 shown in FIGS. 6 and 7 can engage when the connection element 10 is introduced into the aperture 16 of the add-on element 4. In order to facilitate a subcrestal positioning of the implant body 1 with simultaneously submerged healing, the head 11 of the add-on element 4 can have a height 25 of 1.5 mm to 4.5 mm, in particular 1.5 mm to 3.5 mm, and preferably 2.0 mm to 2.5 mm. It can be clearly seen here that the head 11 projects out of the implant body 1 or protrudes/projects from the implant shoulder 34 when the add-on element 4 is connected thereto.

The connection element 10 has a thread 12, via which it can be connected to the thread 13 of the implant body 1, wherein it engages thereby with the shoulder 8 behind the projection 9 of the add-on element 4.

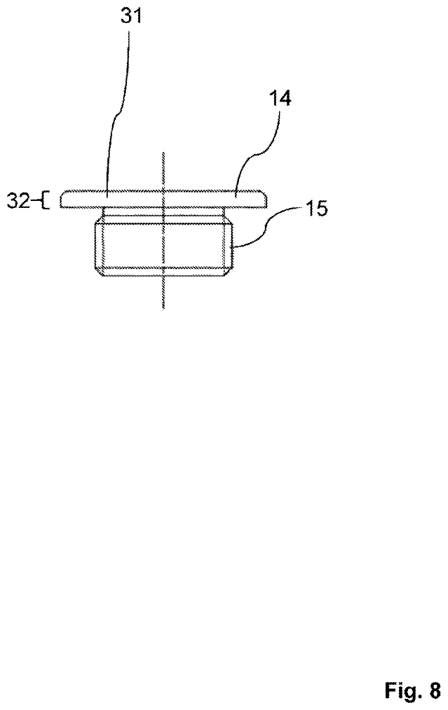

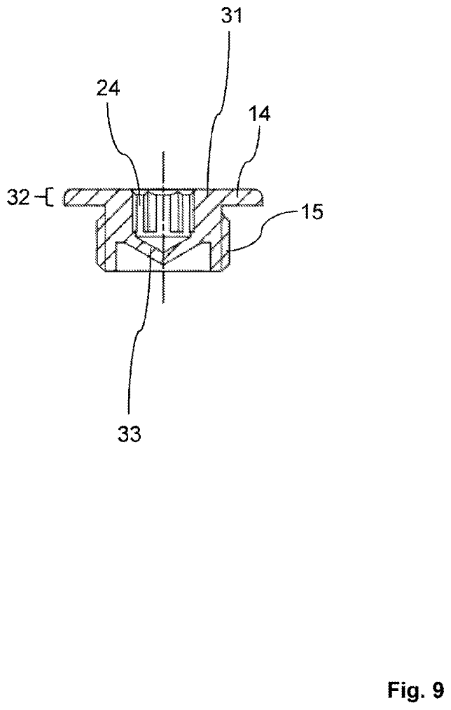

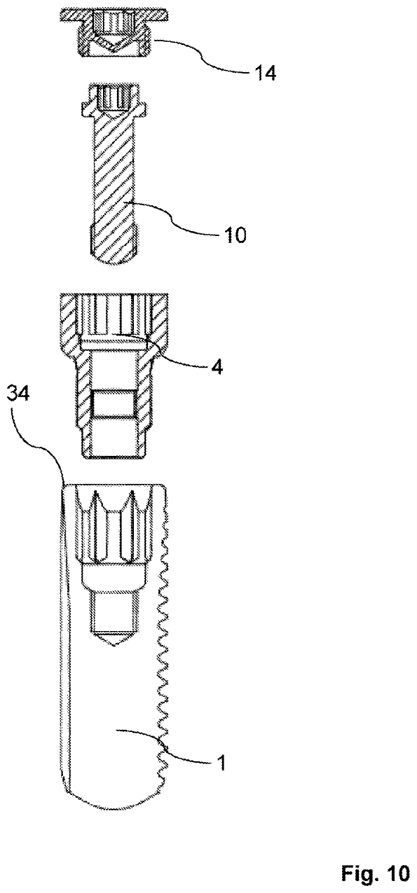

FIGS. 8 and 9 show a first closing element 14 of an implantation system according to the disclosure. A thread 15 is formed on the closing element 14, via which thread 15 the closing element 14 can be connected to the thread 17 of the add-on element 4 in order to close the aperture 16 of the add-on element 4. For this purpose, a profile 24 is provided, on which a corresponding tool can engage. FIG. 5 shows that the thread 17 is provided on the active profile 6 of the add-on element 4. In the exploded view in FIG. 10, the implant body 1, the add-on element 4, the connection element 10, and the closing element 14 of FIGS. 1 through 9 are shown together. If a closing element 14 is arranged, a head 31 of the closing element 14 and the head 11 of the add-on element 4 together can have a height of less than 5 mm, in particular less than 4 mm, and preferably less than 2.8 mm. Thus, in the state connected to the implant body 1, and in particular when they are completely inserted, the closing element 14 and the add-on element 4 project by said height out of the implant body 1 or protrude by said height from the implant shoulder 34. The height 32 of the head 31 of the closing element 14 can be less than 2.5 mm, in particular less than 1.5 mm, and preferably less than 0.5 mm.

It can also be seen in FIG. 9 that the profile 24 is provided in a blind hole, wherein the base of the blind hole is of conical design. A further blind hole is formed on the side, facing away from the profile 24, of the closing element 14, the base of which blind hole has, at least partially, a cone-shaped protrusion 33, which thus receives the conical configuration of the opposite blind hole.

The blind hole formed in the connection element 10, in which the engagement point 23 is arranged, has a geometry corresponding to the base. This makes it possible to realize the closing element 14 with an extremely low height and to screw it deeply into the add-on element 4, such that it protrudes as little as possible from the add-on element 4, in order to facilitate submerged healing. The conical base of the blind hole in the closing element 14 provides enough space that the profile 24 can be formed with a stamp in the blind hole, and material can be displaced accordingly.

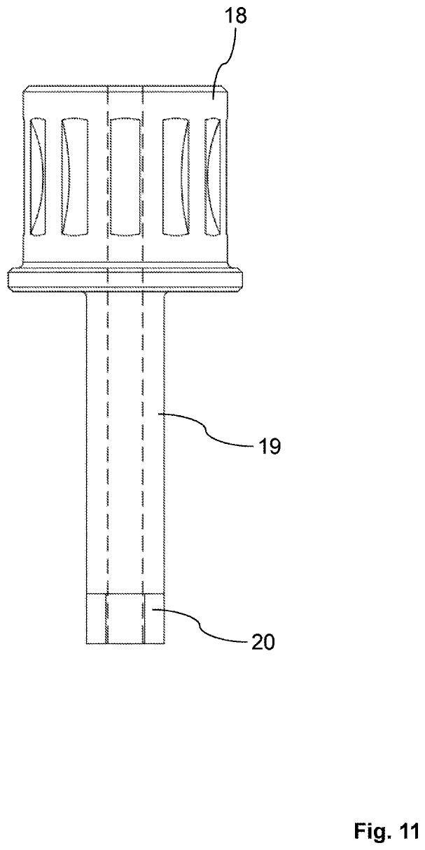

FIG. 11 shows an exemplary embodiment of an instrument 18 of an implantation system according to the present disclosure. The instrument 18 is shown here as a hand instrument and has a shaft 19, at the distal end of which the active element 7 is formed, which corresponds to the active profile 6 of the add-on element 4. Thus, the add-on element 4 can be received with the instrument 18 and optionally inserted by the latter into the bone together with the implant body 1.

Furthermore, it can be seen that the shaft 19 is tubular, such that the rod 21 shown in FIG. 12 can be arranged movably within the shaft 19. At its distal end, the rod 21 has an active geometry 22, which corresponds to an engagement point 23 of the connection element 10. The connection element 10 can thus be screwed into the thread 13 of the implant body 1 with the rod 21.

It is apparent from FIG. 11 that the rod 21 is thus part of a second instrument, which is also realized here as a hand instrument. It is conceivable that the profile 24 of the closing element be designed such that it corresponds to the active geometry 22. In this case, the rod 21 could also serve for attaching the closing element 14.

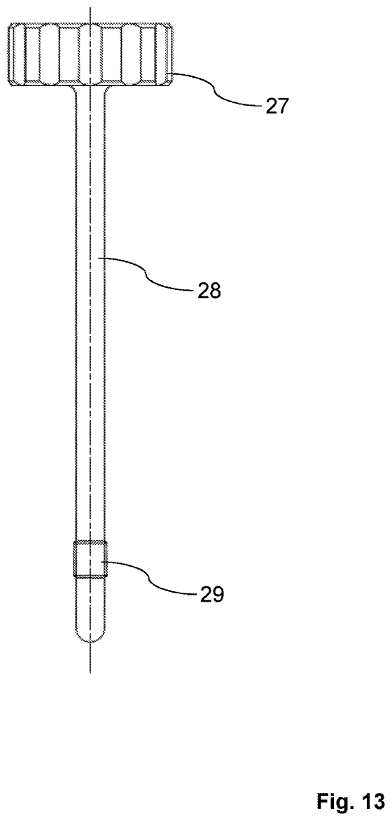

FIG. 13 shows a schematic representation of a release instrument 27. Said release instrument 27 serves to remove or release the add-on element 4 from the implant body 1 after the healing period. For this purpose, the release instrument 27 has a release rod 28, wherein, set back from the distal end of the release rod 28, a release thread 29 is formed. To release the add-on element 4, the closing element 14 and the connection element 10 are, optionally, first removed. The distal end of the release instrument 27 can then be inserted into the aperture 16 of the add-on element 4, and the release thread 29 can be screwed into the lower thread 26. Since the release thread 26 is arranged set back from the distal end of the release rod 28, the distal end of the release rod 28 abuts against the base 30 of the implant body 1. With the further screwing in of the release rod 28, the add-on element 4 is thus pulled off the implant body 1 such that an add-on element 4, which has become partially ingrown, can be easily and non-destructively removed.

With regard to further advantageous embodiments of the device according to the present disclosure, reference is made to the general part of the description and to the appended claims in order to avoid repetitions.

Finally, it is expressly pointed out that the exemplary embodiments described above of the device according to the present disclosure serve only to explain the claimed teaching, but do not limit it to the exemplary embodiments.

### LIST OF REFERENCE NUMBERS

1 Implant body
2 Thread (implant body)
3 Connection inner profile
4 Add-on element
5 Connection outer profile
6 Active profile
7 Active element
8 Projection
9 Shoulder
10 Connection element
11 Head (add-on element)
12 Thread (connection element)
13 Thread (implant body)
14 Closing element
15 Thread (closing element)
16 Aperture
17 Thread (add-on element)
18 Instrument
19 Shaft
20 Active element
21 Rod
22 Active geometry (rod)
23 Engagement point
24 Profile
25 Height (add-on element)
26 Thread (add-on element)
27 Release instrument
28 Release rod
29 Release thread
30 Base
31 Head (closing element)
32 Height (closing element)
33 Protrusion
34 Implant shoulder

The various embodiments described above can be combined to provide further embodiments. These and other changes can be made to the embodiments in light of the above detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An implantation system, comprising:
an implant body;
an add-on element; and
a connection element,
wherein the implant body has a connection inner profile or a connection outer profile, which cooperates with a connection outer profile or with a connection inner profile of the add-on element,
wherein the add-on element is connectable to the implant body in a rotationally-fixed manner, and
wherein the connection element is screwable through an aperture of the add-on element into a thread of the implant body in order to detachably connect the add-on element to the implant body.

2. The implantation system according to claim 1, wherein, in the state of the add-on element connected to the implant body, a head of the add-on element projects out of the implant body or from an implant shoulder by 1.5 mm to 4.5 mm.

3. The implantation system according to claim 1, wherein the add-on element has an active profile for an active element, and wherein the add-on element connected to the implant body via the connection element is implantable.

4. The implantation system according to claim 1, further comprising a closing element that is connectable to the add-on element in a form-fitting and/or force-fitting manner in order to close the aperture of the add-on element.

5. The implantation system according to claim 4, wherein, in the state connected to the add-on element, a head of the closing element projects out of the add-on element by less than 2.5 mm.

6. The implantation system according to claim 4, wherein the closing element and the add-on element are designed configured such that, when they are connected together with the implant body, a head of the closing element and a head of the add-on element project out of the implant body or from an implant shoulder together by less than 5 mm.

7. The implantation system according to claim 4, wherein a thread for the closing element is formed on an active profile of the add-on element.

8. The implantation system according to claim 1, wherein the implant body is configured se to be arranged below bone level.

9. The implantation system according to claim 1, wherein the connection inner profile of the implant body and the connection outer profile of the add-on element, or the connection outer profile of the implant body and the connection inner profile of the add-on element, are configured to achieve a torque transmission of at least 30 N·cm, in particular of at least 40 N·cm, and preferably of at least 50 N·cm, is possible.

10. The implantation system according to claim 1, wherein the connection inner profile of the implant body and an active profile of the add-on element are at least substantially identical.

11. The implantation system according to claim 1, further comprising an instrument, wherein the instrument has a shaft, and wherein an active element is formed at the distal end of the shaft, said active element corresponding to an active profile of the add-on element.

12. The implantation system according to claim 11, wherein the shaft is tubular, wherein a rod is arrangeable or arranged movably within the shaft, and wherein an active geometry is formed at the distal end of the rod and corresponds to an engagement point of the connection element.

13. The implantation system according to claim 1, further comprising a release instrument that is arranged with a release rod, wherein, set back from a distal end of the release rod, is a release thread.

14. An add-on element for an implantation system according to claim 1, having a connection inner profile or having a connection outer profile for producing a rotationally-fixed connection to a connection outer profile or to a connection inner profile of an implant body and having an aperture for introducing the connection element.

15. The implantation system according to claim 2, wherein, in the state of the add-on element connected to the implant body, the head of the add-on element projects out of the implant body or from the implant shoulder by 1.5 mm to 3.5 mm.

16. The implantation system according to claim 2, wherein, in the state of the add-on element connected to the implant body, the head of the add-on element projects out of the implant body or from the implant shoulder by 2.0 mm to 2.5 mm.

17. The implantation system according to claim 5, wherein, in the state connected to the add-on element, the head of the closing element projects out of the add-on element by less than 1.5 mm.

18. The implantation system according to claim 5, wherein, in the state connected to the add-on element, the head of the closing element projects out of the add-on element by less than 0.5 mm.

19. The implantation system according to claim 6, wherein, when the closing element and the add-on element are connected together with the implant body, the head of the closing element and the head of the add-on element project out of the implant body or from the implant shoulder together by less than 4 mm.

20. The implantation system according to claim 6, wherein, when the closing element and the add-on element are connected together with the implant body, the head of the closing element and the head of the add-on element project out of the implant body or from the implant shoulder together by less than 2.8 mm.
